(19) United States
(12) Patent Application Publication
(10) Pub. No.: US 2009/0138401 A1
(43) Pub. Date: May 28, 2009

(54) Electronic traveler's check

(76) Inventor: Damon E. Smith, (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/314,047

(22) Filed: Dec. 3, 2008

Related U.S. Application Data
(63) Continuation-in-part of application No. 11/987,247, filed on Nov. 28, 2007.

(51) Int. Cl. G06Q 40/00

(52) U.S. Cl. 705/44; 235/379

(57) ABSTRACT

The electronic traveler's check system and method includes an electronic traveler' check card that is usable to retrieve money from point of service locations and banks. The system has a database of user information, such as a pin number and the user's passport number, which is used to verify the identity of the user before a transaction can take place. An emergency credit feature is provided to enable transaction completion when a cardholder's account has insufficient cash funds.

### CROSS-REFERENCE TO RELATED APPLICATION

This application is a continuation-in-part of U.S. patent application Ser. No. 11/987,247, filed Nov. 28, 2007, which is hereby incorporated by reference in its entirety.

### BACKGROUND OF THE INVENTION

1. Field of the Invention

The present invention relates generally to electronic monetary systems, and more particularly to an electronic traveler's check for conducting monetary transactions electronically.

2. Description of the Related Art

A traveler in the possession of paper traveler's checks often encounters the necessity of signing many checks in order to complete transactions with foreign retailers and merchants, domestic retailers and merchants, banks, points of sale (POS), and the like. When a traveler is rushed, the check-signing ritual presents a particularly vexatious and annoying problem that the traveler would rather avoid.

To add insult to injury, a traveler who runs out of the checks in a faraway land may also find it difficult to replenish the supply of paper traveler's checks, and thus be far from home with no medium for paying for goods and services. While electronic traveler's checks have been introduced to solve the problem of signing paper checks, such as the electronic traveler's check described in U.S. Pat. No. 6,857,565, issued Feb. 22, 2005 to the present inventor, heretofore the same difficulty of having no funds available occurs when the traveler's account has been exhausted.

Thus, an electronic traveler's check solving the aforementioned problems is desired.

### SUMMARY OF THE INVENTION

The electronic traveler's check (ETC) has verification characteristics that are usable in conjunction with various other foreign and domestic electronic monetary systems, including the issuing financial institution. The ETC is adapted for withdrawing monetary funds from foreign and domestic subscribers with automated teller machines (ATM), point of sale (POS) systems and banks.

A customer purchases an ETC card and deposits as much money as desired in an account linked to the card. The customer is allowed to make as many withdrawals or POS purchases as desired. When the funds are depleted, the customer has the option to add additional funds to their linked account, or to tap into a preapproved credit line that can be used for transactions until the credit line is used up. The ETC has an expiration date that coincides with the expiration date of the customer's passport.

In addition to purchasing the ETC card and making a deposit into a linked account, the customer must also provide verification data and security data. This data is used to prevent fraudulent transactions and to provide card security.

These and other features of the present invention will become readily apparent upon further review of the following specification and drawings.

### BRIEF DESCRIPTION OF THE DRAWINGS

FIG. 1A is a front view of an electronic traveler's check card according to the present invention.

FIG. 1B is a rear view of an electronic traveler's check card according to the present invention.

FIG. 2 is a front view of an application form for applying for an electronic traveler's check according to the present invention.

FIG. 3 is a flowchart of a method for issuance and use of an electronic traveler's check according to the present invention.

FIG. 4 is a block diagram showing elements of an electronic traveler's check system according to the present invention.

FIG. 5 is a front view of an application form in an electronic traveler's check system according to the present invention for automatic transfer of funds from a specific bank to the electronic traveler's check account.

Similar reference characters denote corresponding features consistently throughout the attached drawings.

### DETAILED DESCRIPTION OF THE PREFERRED EMBODIMENTS

The present invention is directed to an electronic traveler's check (ETC), including a system and method having verification characteristics, and which is usable in conjunction with various other foreign and domestic electronic monetary systems, including the issuing financial institution. The ETC card is adapted for withdrawing monetary funds from foreign and domestic subscribers with automated teller machines (ATM), point of sale (POS) systems, and banks.

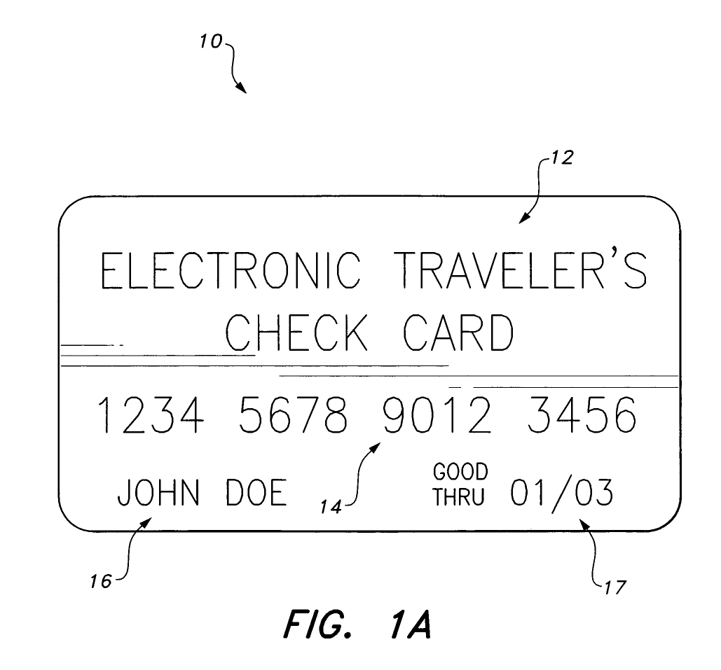

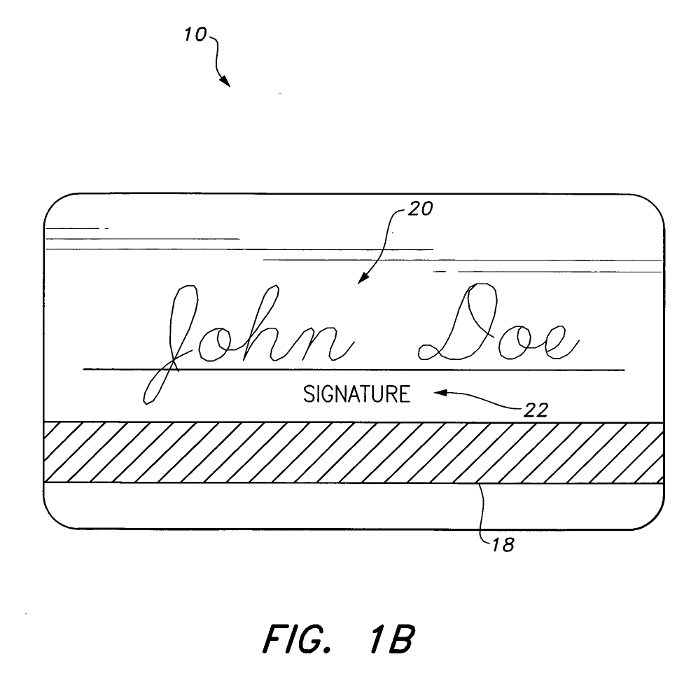

The ETC card, as depicted in FIGS. 1A (front face) and 1B (rear face) is an Electronic Traveler's Check Card 10, which may comprise a rectangular plastic electronic traveler's check (ETC) card having verification characteristics, such as the Electronic Traveler's check indicia 12, account number 14, and printed user's name 16, represented as “John Doe” on the exemplary front face (FIG. 1A) of the ETC 10 of FIG. 1A. An expiration date 17 is stamped on the card as a necessary security measure. In this example, the ETC 10 will expire in January of 2003.

As shown in FIG. 1B, the rear face of the ETC 10 has a signature blank 20 for the cardholder's signature appearing over appropriate signature indicia 22. A conventional magnetic strip 18 is attached to the card having appropriate information stored thereon to identify the cardholder.

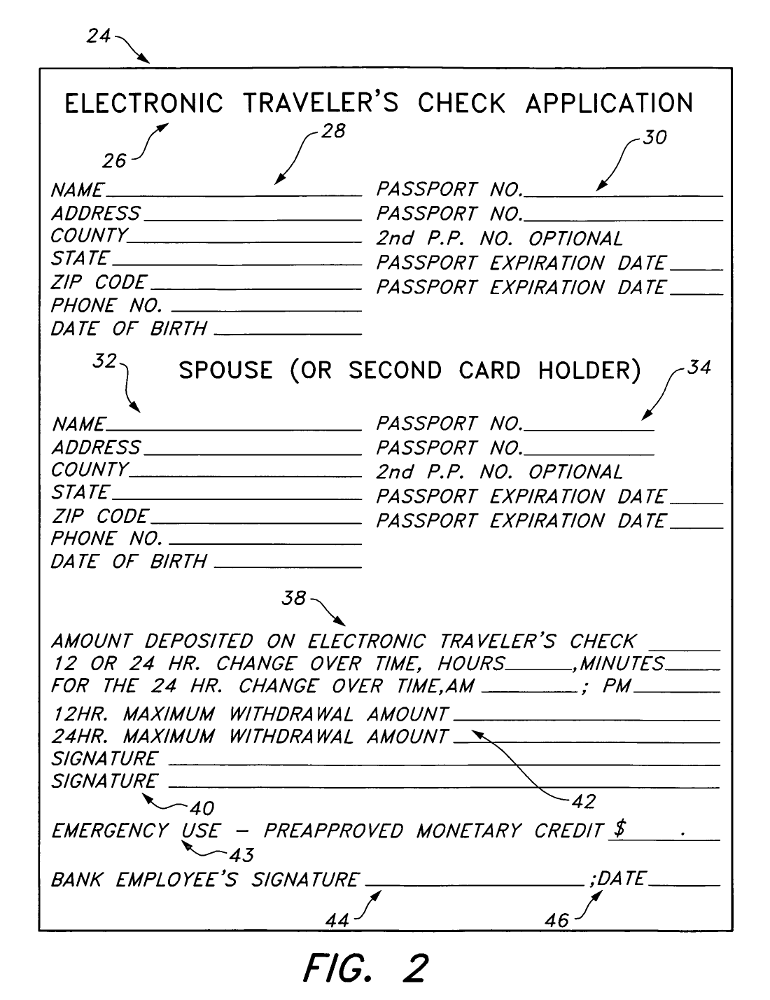

In order to obtain an ETC card 10, a user fills out an application form, such as the exemplary form 24 of FIG. 2 that is provided by a participating vendor and pays the amount of money credit requested. In exemplary form 24, the title 26 identifying the application as an ETC Application is located at the top. The user's name, address, phone number, and date of birth must be entered in the area marked 28. The user's passport number or numbers and expiration date(s) 30 must be entered. If the user has dual citizenship in different countries, the user must supply both passport numbers. If the user has a spouse or another person traveling with him, the second address, related information 32 and passport number(s) 34 must be filled out, together with the birth date.

A 12- or 24-hour maximum withdrawal amount 42 is provided under the title 38, “AMOUNT DEPOSITED ON ELECTRONIC TRAVELER'S CHECK” in terms of hours and minutes for the “12- or 24-HR. CHANGE OVER TIME,” and in time of the day in “AM” and “PM” “FOR THE 24-HR. CHANGE OVER TIME”.

Field 43 provides entry space for a user preapproved credit request, including a dollar amount requested.

The space for signature(s) 40 of the user(s) must be filled out. The application 24 is authenticated upon receipt of the money by the signature 44 of a bank employee and dated at 46. The rationale for limiting the withdrawal is that in the event that the ETC 10 and the PIN number are stolen, the criminal can only withdraw the maximum amount of money permitted during the 12- or 24-hour period, giving the legal card owner time to cancel the stolen ETC 10.

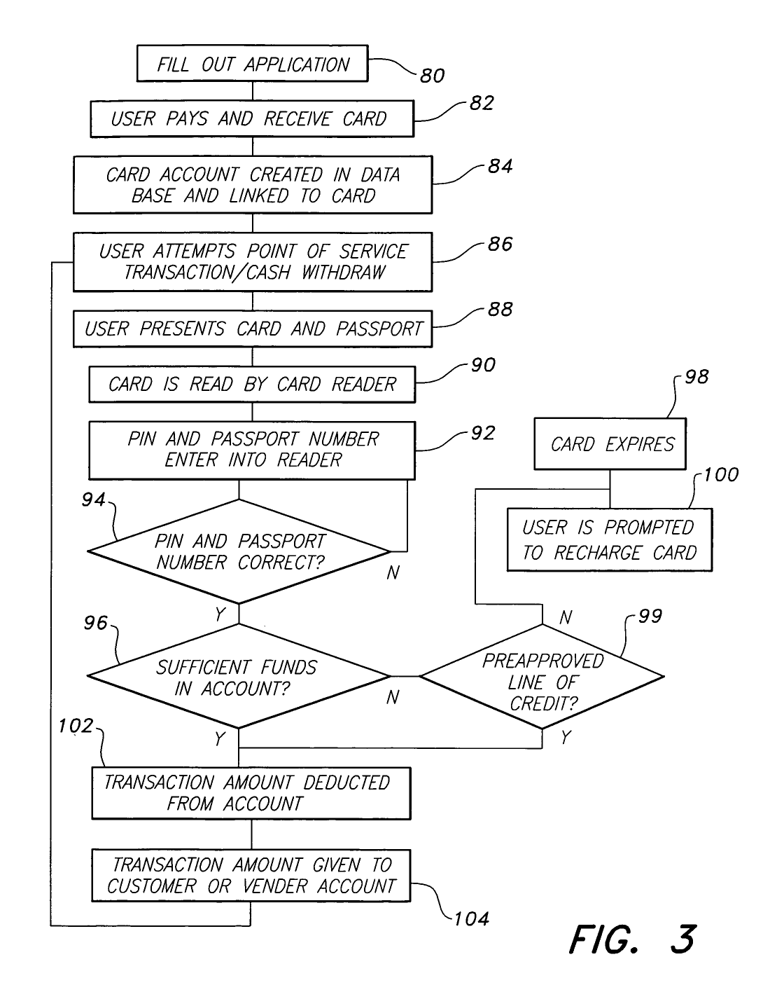

FIG. 3 illustrates an overview of a method of issuing and using the ETC 10. Once the application 24 has been properly filled out, as indicated at step 80, the user transfers funds to the card vendor and receives the ETC card from the vendor, as shown at step 82. At step 84, a card account is created in a database and linked to the card, thereby activating the card. The linked account may be stored in the database, provided it is accessible by a server. The server may preferably be connected to the Internet, or accessible by telephone.

The process of withdrawing funds from the electronic traveler's check account at a banking institution or a point of sale begins at step 86, and includes a number of steps implementing security precautions, as shown in FIG. 3. At step 88, the user must present the ETC 10 and his passport to the appropriate bank or vendor clerk.

At step 90, the clerk then takes the ETC 10 and uses a magnetic reader with an attached keypad to read the magnetic strip 18 on the back of the card and input that information into a computer network.

At step 92, the clerk will then enter the user's passport number into the keypad on the magnetic reader and verify that the passport picture matches the user.

The user then enters his PIN and the amount of currency requested for withdrawal from the traveler's check account into the keypad.

At step 94, the server then verifies the user's passport number and PIN, and if both are correct, electronically transfers the funds and generates a receipt.

Optionally, the receipt is sent to the reader and printed so that the user may then sign a receipt. The signature can be compared to the signature on the back of the ETC by the clerk for further security. If sufficient funds are present, the funds are deducted from the linked account at step 102, and provided to the user or the merchant at step 104.

The customer purchases an ETC card and deposits currency in an account linked to the card. The customer is allowed to make as many withdrawals or Point of Sale purchases as desired. When the funds are depleted, the customer may add funds to the linked account at step 100 or, as shown at step 99, if a preapproved line of credit has been established on the card, the customer may continue using the card at step 102, where the transaction amount is deducted from the account.

The card has an expiration date that coincides with the expiration date of the customer's passport. By having the ETC card expire on the same date as the passport, the ETC card-issuing company can issue a new ETC card prior to the expiration of the cardholder's passport, which will also serve as a reminder to the customer that their passport is soon to expire.

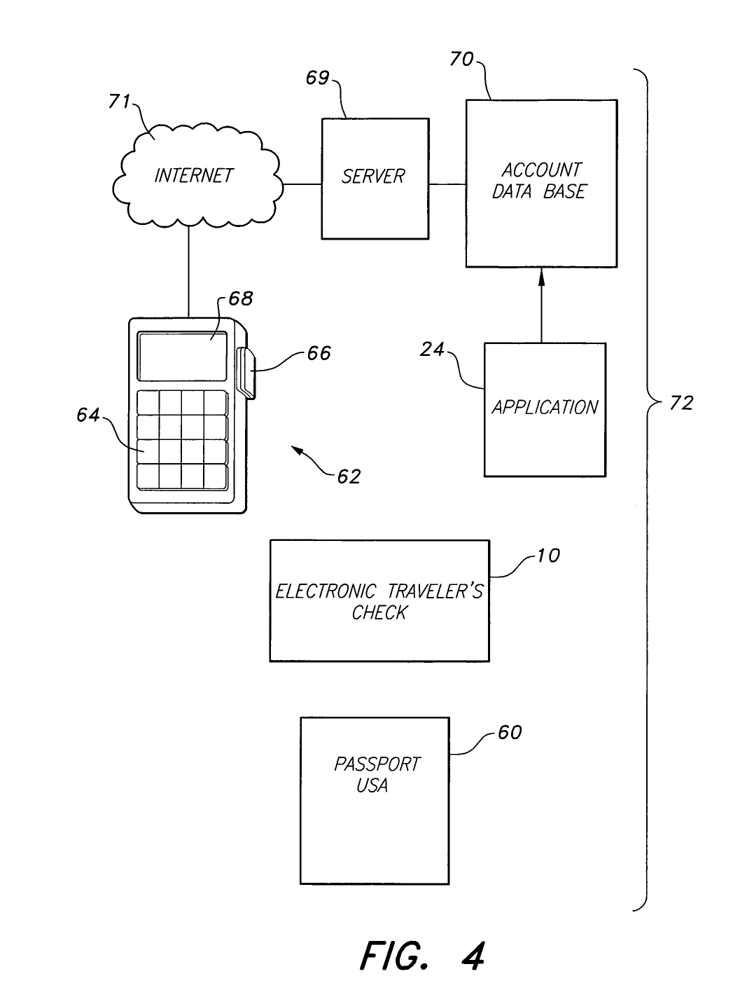

FIG. 4 shows components comprising the ETC system 72. The information from the check application 24 is entered into an account database 70, which is accessible by a server 69. A server is well known in the art and ordinarily comprises a processor, area main memory, hard disk memory and a power source. The server is preferably connected to the Internet 71. A card reader 62 having a screen 68, a keypad 64 and a magnetic strip reader 66 may be used to read the ETC card 10 and input passport 60 data into the server 69.

The server 69 compares the information sent by the card reader 62 to the information present in the database 70 and determines whether the data is correct. The server 69 also determines whether there are sufficient funds present in the account to complete the proposed transaction. The process may also be completed without the use of the Internet 71 by establishing a direct dial communications link between the reader 62 and the server 69.

It is well within the ability of one skilled in the art to substitute an ATM machine for the card reader 62. The only difference is that there would be a limit per transaction period on the amount of funds that could be withdrawn'from the linked account. This limit is not present in POS and bank transactions.

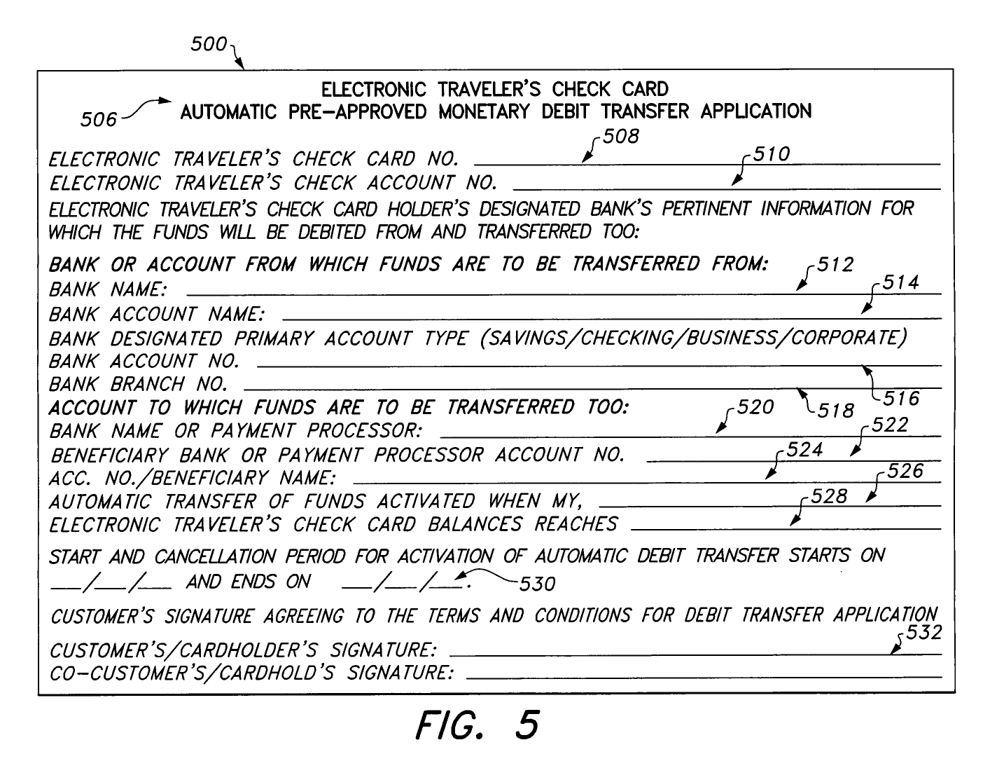

The addition of a pre-approved credit line to an electronic traveler's check 10 makes the ETC 10 competitive with conventional ATM cards while traveling, and offers additional security precautions to combat the problem of card theft, both in a foreign country and domestically. Moreover, as shown in FIG. 5, the system in conjunction with server 69 can be responsive to an automatic pre-approved monetary debit transfer application 500. Upon completion by an applicant of form fields 508, 510, 512, 514, 516, 518, 520, 522, 524, 526, 528, 530, and 532, the system can approve/disapprove the application. If the application is approved, the system automatically debits a pre-approved monetary amount from a pre-approved, designated account, i.e., savings, checking, business or corporate account held by the card holder/applicant should the ETC card 10 account balance fall below a pre-designated monetary amount, e.g., $25 while the card holder is traveling. Funds transferred from any of the Electronic Traveler's Check card holder(s) designated savings, checking, business, corporate or any other accounts held by the Electronic Traveler's Check card holder onto the Electronic Traveler's Check card account will be made available for usage by the cardholder while he/she is traveling. The ETC card holder can set a start and cancellation date/time for the automatic debiting or transfer of funds into the ETC card account prior to the start of any travel or usage of the ETC card 10. Automatic debiting or transferring of funds onto the ETC card gives the ETC card customer the option of either pre-approved credit or pre-approved automatic debiting of funds from any pre-approved account, should the customer need extra funds during his/her travels.

It is to be understood that the present invention is not limited to the embodiment described above, but encompasses any and all embodiments within the scope of the following claims.

I claim:

1. An electronic traveler's check system for a traveler having a passport, the system comprising:
an electronic traveler's check (ETC) card for issuance to the traveler, the card having verification characteristics and a magnetic strip, the card being associated with an account opened by the traveler and having an amount of currency deposited therein by the traveler and a credit line preapproved for the traveler;
a card reader having a keypad, a magnetic strip reader, and a display;
a server;
a database connected to the server, the database containing information relating to the traveler to whom the electronic traveler's check card is issued, including the traveler's passport number and expiration date, the traveler's account number, the amount of currency deposited by the traveler, and the traveler's preapproved credit line;
means for allowing communication between the card reader and the server;
means for verifying data from the card reader;
means for verifying currency account and electronically transferring money up to the amount of currency deposited by the traveler; and
means for verifying credit line account data and electronically transferring money up to the traveler's preapproved credit line when the amount of currency deposited by the traveler is depleted.

2. The electronic traveler's check system according to claim 1, wherein said electronic traveler's check card expires upon the expiration date of the passport.

3. The electronic traveler's check system according to claim 1, wherein said means for verifying currency data further comprises means for prompting a customer to add funds to a depleted card.

4. The electronic traveler's check system according to claim 1, further comprising:
means for generating a receipt; and
means for printing the receipt.

5. The electronic traveler's check system according to claim 1, further comprising means for restricting withdrawal amounts from the amount of currency deposited by the traveler in a particular time period.

6. The electronic traveler's check system according to claim 1, further comprising means for automatically debiting a pre-approved monetary amount from a pre-approved, designated account and crediting said same amount to the ETC card holder's account when the ETC card account balance falls below a pre-determined monetary amount.

7. An electronic traveler's check card method, comprising the steps of:
(a) accepting an electronic traveler's check card and a passport presented by a user;
(b) reading information stored on the electronic traveler's check with a magnetic card reader;
(c) entering the user's passport number and personal identification number into the magnetic card reader;
(d) verifying the passport number and the personal identification number;
(e) verifying that sufficient funds are present in an account linked to the card; and
(f) verifying a credit line limit linked to the card when the funds present in the account are depleted.

8. The electronic traveler's check card method according to claim 7, further comprising the step of verifying that a picture on said passport matches the user of said card.

9. The electronic travelers check card method according to claim 7, further comprising the steps of:
generating a receipt;
having the user sign the receipt;
comparing the user's signature to a signature on the back of said traveler's check card.

10. The electronic travelers check card method according to claim 7, further comprising the step of refusing to honor the electronic traveler's check card when the passport has expired.

11. The electronic traveler's check card method according to claim 7, further comprising the steps of:
verifying a maximum withdrawal limit for a user-selectable time period, the user-selectable time period being established when the electronic traveler's check card is issued; and
refusing to honor a request for withdrawal when the maximum withdrawal limit would be exceeded.

12. The electronic traveler's check card method according to claim 11, wherein the user-selectable time period is selected from the group consisting of twelve hours and twenty-four hours.

13. The electronic traveler's check card method according to claim 7, wherein steps (d), (e), and (f) further comprise connecting the magnetic card reader with a database through a server on a computer network.

14 The electronic traveler's check card method according to claim 13, wherein the network is the Internet.

15. The electronic traveler's check card method according to claim 7, further comprising the steps of:
automatically debiting a pre-approved monetary amount from a pre-approved, designated account; and
crediting said same amount to the ETC card holder's account when the ETC card account balance falls below a pre-determined monetary amount.
